(19) United States
(12) Patent Application Publication
(10) Pub. No.: US 2012/0037419 A1
(43) Pub. Date: Feb. 16, 2012

(54) CABLE TERMINATION APPARATUS AND RELATED METHODS

(75) Inventors: Konrad Mech, North Vancouver (CA); Brian Spira, Edmonton (CA)

(73) Assignee: DEXRAN ENERGY SYSTEMS INC., Burnaby, BC (CA)

(21) Appl. No.: 13/257,578

(22) PCT Filed: Mar. 19, 2010
(86) PCT No.: PCT/CA2010/000427

§ 371 Date: Sep. 19, 2011

Related U.S. Application Data
(60) Provisional application No. 61/162,159, filed on Mar. 20, 2009.

(51) Int. Cl. H02G 15/02; H01R 43/00; H02G 15/04

(52) U.S. Cl. 174/77 R; 174/74 A; 29/857

(57) ABSTRACT

In one embodiment, the termination apparatus provides a means for terminating certain elongate heat tracing products that have corrugated metal sheaths as outer covering for those elongate heaters. The heat tracing products may include oval corrugated metal sheaths as outer covering. Terminating other types of cables, including cables which provide electrical power or electromagnetic signals, is also contemplated.

### REFERENCE TO REALTED APPLICATION

This application claims priority from U.S. patent application No. 61/162159 filed on 20 Mar. 2009 and entitled

TERMINATION APPARATUS FOR HIGH TEMPERATURE HEATING CABLES. For the Purposes of the United States of America, this application claims the benefit under 35 U.S.C. §119 of U.S. application No. 61/162159 filed on 20 Mar. 2009 and entitled TERMINATION APPARATUS FOR HIGH TEMPERATURE HEATING CABLES which is hereby incorporated herein by reference.

### TECHNICAL FIELD

The invention relates to terminating cables. Particular embodiments generally relate to termination apparatus for heating cables.

### BACKGROUND

Heating, power and other types of cables need to be safely terminated in a wide variety of environments. In some situations, cables must be electrically connected to other cables, either of the same type or different types, or connected to other electrical components. Such connections are often made within a protected electrical enclosure. In other situations cables need to be simply terminated without connecting to other cables or other components.

Prior art systems for connecting and/or terminating cables include:
United States Patent Application Publication No. 2010/0035457 to Holliday;
U.S. Pat. No. 7,648,373 to Dixon et al.;
U.S. Pat. No. 6,267,621 to Pitschi et al.;
U.S. Pat. No. 5,789,706 to Perkins;
U.S. Pat. No. 5,518,420 to Pitschi;
U.S. Pat. No. 4,538,053 to Morrow et al.;
U.S. Pat. No. 4,387,267 to Becker;
U.S. Pat. No. 4,022,966 to Gajajiva;
U.S. Pat. No. 4,030,741 to Fidrych;
U.S. Pat. No. 3,567,843 to Collins et al.;
U.S. Pat. No. 3,371,150 to Bachman;
U.S. Pat. No. 3,176,064 to Browne; and,
U.S. Pat. No. 1,345,473 to Benjamin.

The inventors have determined a need for improved apparatus and methods for terminating cables.

### SUMMARY

One aspect of the invention provides an apparatus for terminating a cable having a corrugated sheath. The apparatus comprises a body having a terminating portion and a cable receiving portion. The terminating portion has an aperture defined therethrough. The cable receiving portion comprises an extension projecting outwardly in a direction away from the terminating portion. The extension has an extension channel defined in a central portion thereof and one or more locking features protruding into the extension channel near an outward end thereof. The apparatus also comprises a cap configured to be secured to the extension of the body and one or more fasteners for securing the cap to the extension of the body. The cap has a cap channel defined in a central portion thereof and one or more locking features protruding into the cap channel near an outward end thereof. When the cap is secured to the extension the extension channel and the cap channel cooperate to define a compression chamber therebetween. The compression chamber is generally aligned with the aperture through the terminating portion, and the locking features protruding into the extension channel and the cap channel are configured to engage the corrugated sheath of the cable.

Another aspect of the invention provides a method of terminating a cable having a corrugated sheath. The method comprises providing a body having a terminating portion and a cable receiving portion, the terminating portion having an aperture defined therethrough, the cable receiving portion comprising an extension projecting outwardly in a direction away from the terminating portion, the extension having an extension channel defined in a central portion thereof and one or more locking features protruding into the extension channel near an outward end thereof, and a cap configured to be secured to the extension of the body, the cap having a cap channel defined in a central portion thereof and one or more locking features protruding into the cap channel near an outward end thereof, coupling the terminating portion to an electrical enclosure, inserting an end of the corrugated sheath through the aperture in the terminating portion and positioning the corrugated sheath in the extension channel such that the one or more locking features of the extension engage a corrugation of the corrugated sheath, and, securing the cap to the extension using one or more fasteners, such that the extension channel and the cap channel cooperate to define a compression chamber around the corrugated sheath, the compression chamber being generally aligned with the aperture through the terminating portion, and such that the one or more locking features of the cap engage a corrugation of the corrugated sheath.

Further aspects and details of example embodiments are set out below.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 shows a termination apparatus according to one embodiment.

FIG. 2 is a longitudinal sectional view of the termination apparatus of FIG. 1.

FIG. 3 shows the cap and the body of the termination apparatus of FIG. 1.

FIGS. 4A-C show example fasteners for termination apparatus according to various embodiments.

FIGS. 5A-C show example compression chamber shapes according to various embodiments.

FIGS. 6A-6D and 7A-C show example locking features according to various embodiments.

FIG. 8 shows a termination apparatus according to one embodiment.

FIGS. 9A and 9B are sectional views taken along lines A-A and B-B of FIG. 8, respectively.

FIG. 10 shows a termination apparatus according to another embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Termination apparatus according to some embodiments comprise a metal body and a metal cap which together form a half shell metal fitting assembly. The half shell metal fitting assembly grips the metal sheath of a heating cable by raised indentations on the inner surfaces of the body and cap (referred to as “locking ridges” below), or by other locking features, and also compresses the interface between the shell and the sheath by the action of the approaching two half shells being tightened. Particular embodiments provide a combination of gripping, compressing and sealing of the oval, corrugated sheath. Particular embodiments also provide a combination of sealing boots and sealants with the half shell assembly applying pressure on them to affect the sealing. Particular embodiments also provide electrical grounding of the sheath.

Termination apparatus according to some embodiments provide one or more of the following functions:
To maintain the environmental integrity of the sheath.
To prevent the entry of water into the core of the heating cable.
To provide strain relief for the heating cable such that any loads that are imposed on the cable as it enters the electrical connection means are spread out and not concentrated such that the sheath of the heating cable cracks, etc.
To provide an electrical ground path from the heating cable metallic sheath to the system electrical ground.
To prevent the entry of explosive gases into either the heating cable or an electrical enclosure where a spark may occur during energizing of the heating cable resulting in explosion.

Termination apparatus according to some embodiments comprise a universal fitting with a compression chamber within which an end of a heating cable is terminated and which has a threaded nipple, allowing the termination apparatus to be joined to any number of electrical enclosures, junction boxes, or electrical connectors. In such embodiments, the compression chamber is accessed by a removable cap in the form of a split half collar that allows the metallic sheath of the prepared heating cable, which has annular corrugations, to be positioned and captured by a locking ridge. The locking ridge provides mechanical strain relief thereby preventing the heating cable from being pulled out of the termination apparatus by axial load. In some situations, the end of the heating cable is de-energized prior to being positioned in the termination apparatus, such that the portion of heating cable in and/or near the termination apparatus does not produce heat. In other situations the end of the heating cable may remain energized.

Some embodiments provide a termination apparatus uniquely designed to fit onto, as well as provide strain relief and sealing on an oval, corrugated metal sheath of high temperature heater products. For example, some embodiments are particularly suitable for use with CMH heater products such as those described in United States Patent Application Publications No. 2009/0283513, No. 2009/02835134 and No. 2009/02835135, all of which are hereby incorporated herein by reference.

Particular embodiments can be used in a range of products designated as CMH. This range includes generally and is not limited to:
wattages of from 5 to 30 watts/foot of heater
voltages of from 120 to 600 VAC
three sizes of sheath— 5/16″, ⅜″, and ½″ nominal round diameter
corrugations of about 10/inch of heater length

In some embodiments, a sealing boot made of silicone rubber, elastomer, polymer or other similar material is designed to fit over the prepared cable. The use of elastomers to terminate a high temperature heater is acceptable here due to characteristics of the CMH heating cable. Due to the design of CMH heating cables, the preparation method of the cable for termination de-energizes the heater proximate to the termination apparatus, resulting in much lower temperatures in the de-energized zone than those temperatures in the operating zone. This dead length of heating cable is a short de-energized length of the entire heating cable being terminated, thereby having the function of a cold lead assembly. This dead length is created in the field through preparation of the stock cable, and not by factory assembly of a separate unit or field installation of a separate component. In some embodiments, the termination apparatus may be used to terminate a lower temperature heater, or another type of cable such as, for example, a cable providing electrical power, or a cable providing electromagnetic signals.

Termination apparatus according to some embodiments are designed so that the boot provides a gas tight environmental seal when positioned in the chamber. The tip of the boot penetrates an aperture such as, for example a machined chamber through a threaded nipple that closely matches the oblong dimension of the heater assembly, while the tail of the boot is compressed by the split half collar, thereby sealing the boot at each crest of the annular corrugations in the heating cable. The apparatus can be suitably modified to function with heater sheaths having helical corrugations by designing an angled offset to the locking ridge also. The apparatus is sealed when the removable split half collar is positioned and secured in position using one or more fasteners such as, for example threaded fasteners, thereby applying radial compression on the silicone rubber boot. Use of field applied silicone sealant aids in lubricating the boot during installation, and sealing the completed assembly after the sealant sets.

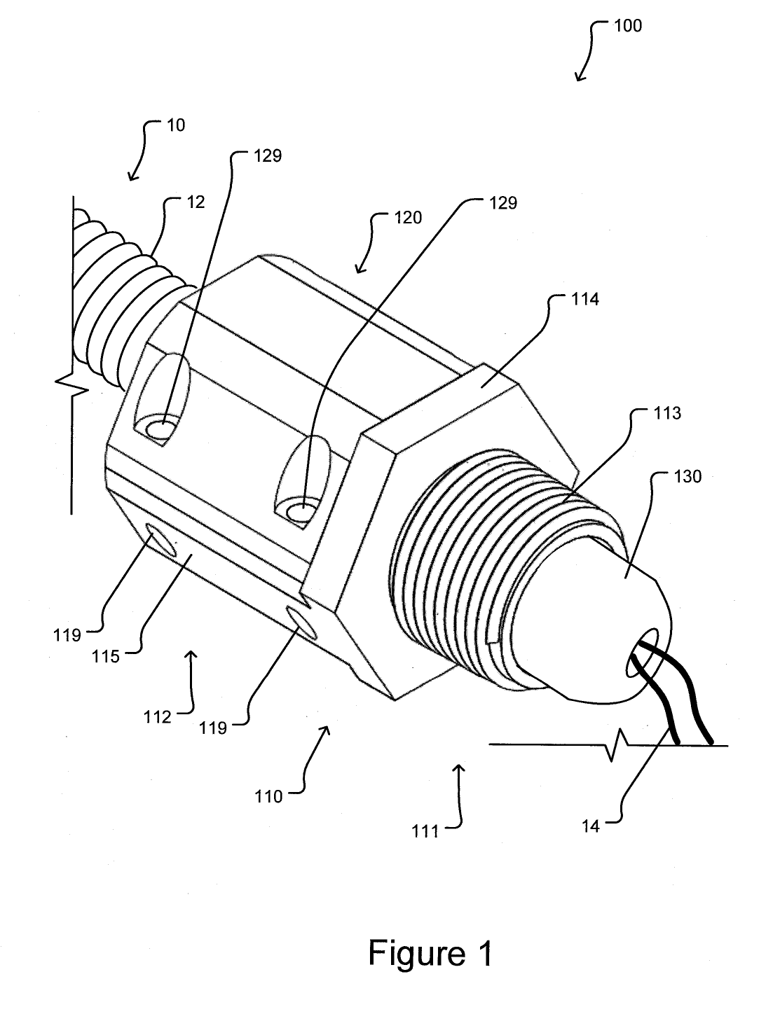

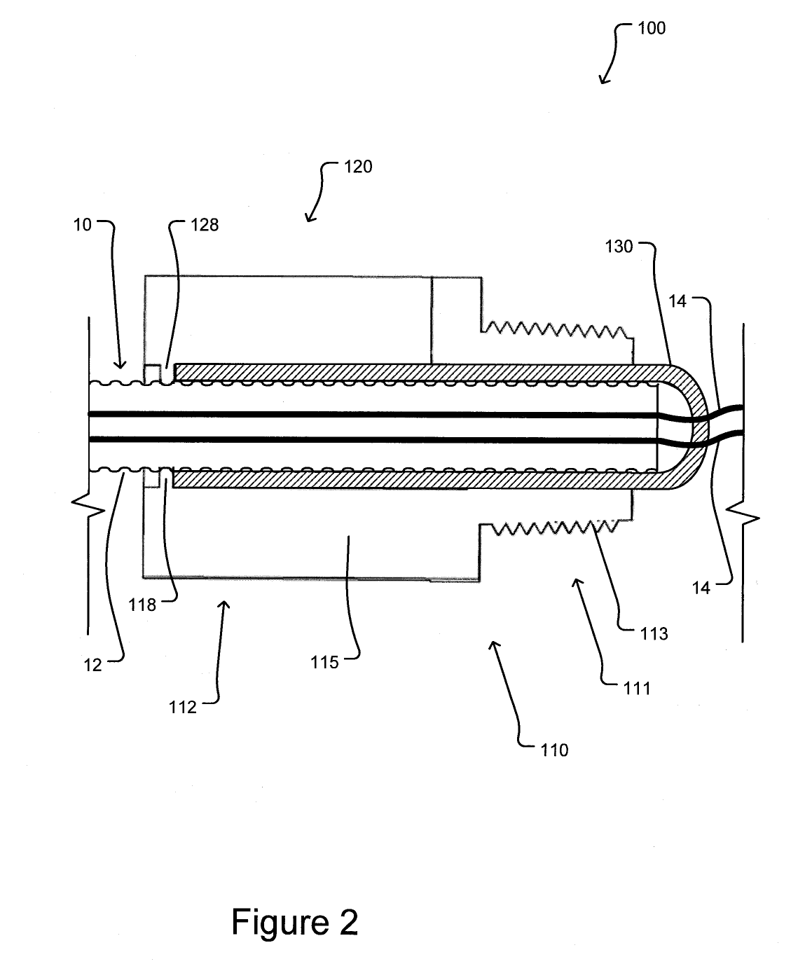

FIGS. 1 to 3 show a termination apparatus 100 according to an example embodiment. Apparatus 100 comprises a body 110 and a cap 120 removably secured thereto by one or more fasteners (not shown in

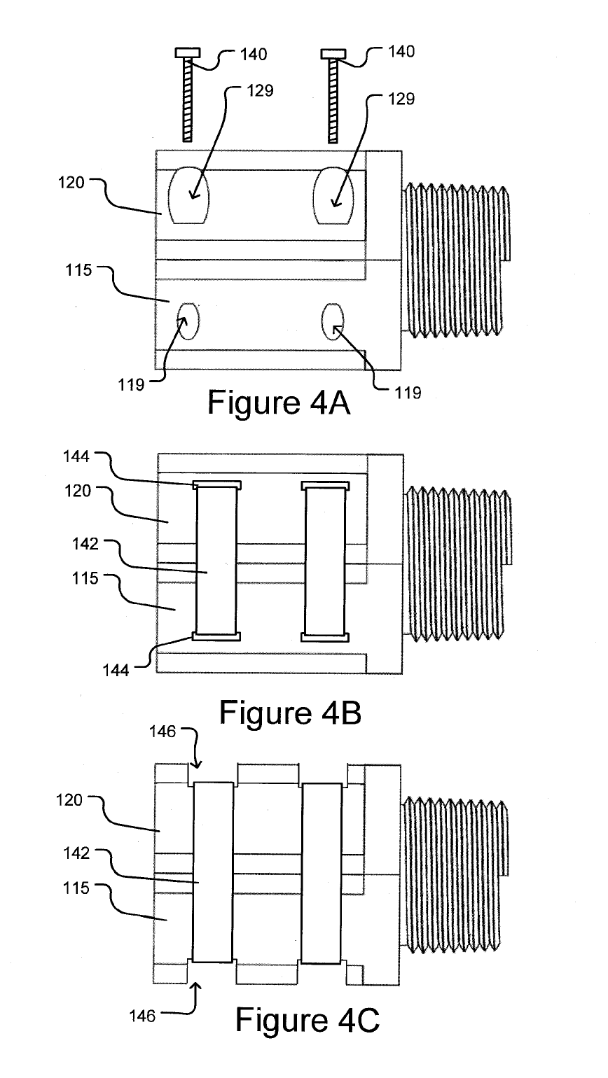

FIGS. 1 to 3, see FIGS. 4A-C). Apparatus 100 may be used for terminating cables such as, for example a heating cable 10 having an annularly corrugated sheath 12. Within sheath 12, heating cable 10 comprises a heating element (not shown) and bus wires 14 for providing electrical power to the heating element, as well as other elements such as spacers and one or more insulation layers (not shown).

In embodiments wherein grounding of sheath 12 is required, body 110 and cap 120 are made from an electrically conductive material. In some embodiments, body 110 and cap 120 may be made from metallic materials selected to ensure absence of galvanic corrosion due to dissimilar metals. For example, when apparatus 100 is configured for use with a stainless steel sheath 12, body 110 and cap 120 may be made from nickel-plated brass or stainless steel. Those skilled in the art will recognize that other materials may be used in other situations (for example, aluminum can be used for cables with aluminum sheaths and so on).

Body 110 comprises a terminating portion 111 and a cable receiving portion 112. Terminating portion 111 is configured to be coupled to an electrical enclosure or the like, and has an aperture defined therethrough for allowing cable 10 and boot 130 to pass into the electrical enclosure. The aperture through terminating portion 110 may comprise, for example, a machined aperture which is slightly larger in cross section than sheath 12, such that an interference fit with boot 130 is created to form a seal. In some embodiments, terminating portion 111 is configured to be coupled to a variety of standard electrical enclosures or boxes, or to other connection apparatus such as, for example and without limitation, those described in PCT Publication No. WO 2009/082815 entitled MULTIPURPOSE CABLE CONNECTOR, which is hereby incorporated by reference herein. If cable 10 does not need to be connected to any other elements, and simply needs to be safely terminated, apparatus 100 may be used to form an end seal by insulating bus wires 14 and screwing a pipe cap onto threaded coupler 113, such that the pipe cap serves as the electrical enclosure.

In the illustrated embodiment, terminating portion 111 comprises a standard threaded coupler 113 such as, for example a NPT thread. Terminating portion 111 may also comprise a hexagonal portion 114 to facilitate tightening of threaded coupler 113 into a suitable receptacle in an electrical enclosure or the like by a wrench or other tool.

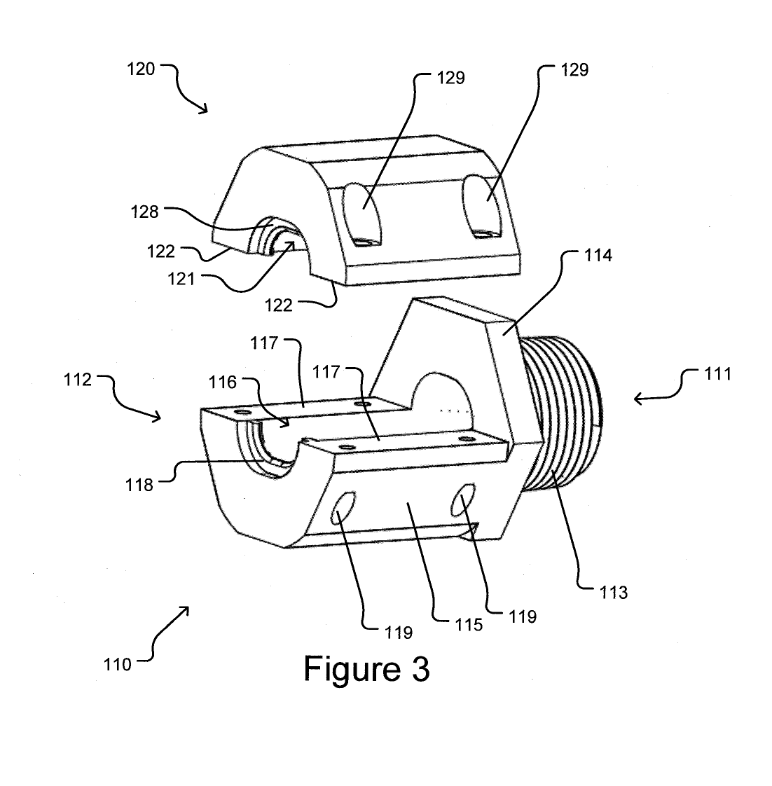

Cable receiving portion 112 of body 110 comprises an extension 115 projecting outwardly away from terminating portion 111. As best seen in FIG. 3, extension 115 has a channel 116 defined therein. On either side of channel 116, extension 115 comprises coplanar flat surfaces 117. Cap 120 likewise has a channel 121 defined therein, with coplanar flat surfaces 122 on either side of channel 121. When cap 120 is secured to extension 115 of body 110, flat surfaces 117 and 122 are held flush against each other, and channels 116 and 121 cooperate to define a compression chamber therebetween. The compression chamber is generally aligned with the aperture through terminating portion 111 such that cable 10 may extend through the compression chamber and the aperture.

Locking features for engaging sheath 12 of cable 10 are provided in the form of a locking ridge 118 near the outer end of channel 116 and a locking ridge 128 near the outer end channel 121. In the embodiment of FIGS. 1 to 3, locking ridge 118 is integrally formed as part of extension 115 and locking ridge 128 is integrally formed as part of cap 120, but other types of locking features are also possible, as discussed below. In embodiments wherein grounding of sheath 12 is required, locking ridges 118 and 128 are made from electrically conductive material to provide a ground path through terminating portion 111 of body 110 to an electrical enclosure or the like.

A boot 130 is positioned over the end of cable 10, with bus wires 14 protruding from an opening (or from two separate openings) in the end of boot 130. Boot 130 is made of a compressible material such as, for example silicone rubber, elastomer, polymer or other similar material. When apparatus 100 is in use, boot 130 is compressed against sheath 12 between body 110 and cap 120, thereby establishing an environmental seal around cable 10. Alternatively, in some embodiments, an environmental seal may be established without the use of boot 130 by wrapping tape such as, for example, self-amalgamating rubber tape around the portion of sheath 12 which is to be received in apparatus 100.

When apparatus 100 is installed, bus wires 14 can be connected to appropriate conductors within an electrical enclosure using any acceptable connection method including but not limited to crimp connectors, screw terminals, cage clamps, soldering, Marr™ connectors, or other connectors.

In the embodiment of FIGS. 1 to 3, extension 115 of body 110 has a plurality of threaded holes 119 extending therethrough, and cap 120 has a plurality of correspondingly located holes 129 extending therethrough, such that cap 120 may be secured to extension 115 using threaded fasteners 140, as shown in FIG. 4A. Holes 119 and 129 are located around the periphery of extension 115 and cap 120, respectively, so as to avoid penetrating the compression chamber, and to evenly distribute clamping forces over flat surfaces 117 and 122.

Other types fasteners could also be used to secure cap 120 to extension 115. For example, FIGS. 4B and 4C show embodiments wherein straps 142 are used to secure cap 120 to extension 115. Straps 142 may comprise, for example, steel straps, pipe straps, nylon ties, or the like.

In the FIG. 4B embodiment, straps 142 pass through slots 144 defined through cap 120 and extension 115. In the FIG. 4C embodiment, straps 142 are received in grooves 146 defined in cap 120 and extension 115. As one skilled in the art will appreciate, other types fasteners could also be used.

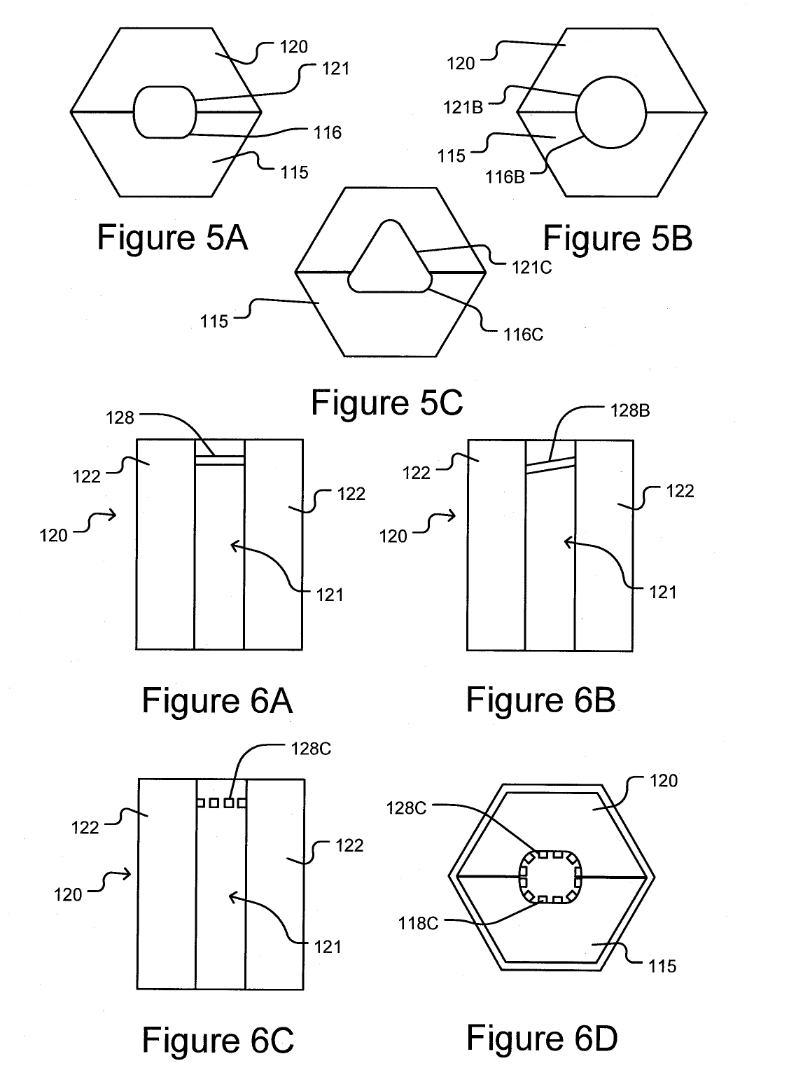

The shapes and sizes of channels 116 and 121 are selected based on the configuration of the sheath of the cable to be terminated by apparatus 100. For example, in the embodiment of FIGS. 1 to 3, channels 116 and 121 have semi-oval shapes such that they cooperate to form a compression chamber having an oval-shaped cross section, as shown in FIG. 5A. Channels 116 and 121 are sized such that when cable 10 and boot 130 are therebetween and cap 120 is secured to extension 115, boot 130 is compressed against sheath of cable. Also, the clamping force exerted on the sheath of the cable is prevented from exceeding some predetermined maximum, since once flat surfaces 117 and 122 contact each other further tightening of the fasteners securing cap 120 to extension 115 is prevented.

The channels in cap 120 and extension 115 may also have other shapes and sized. For example, FIG. 5B shows semi-circular channels 116B and 121B which cooperate to form a compression chamber having a circular cross section. FIG. 5C shows channels 116C and 121C which cooperate to form a compression chamber having a triangular cross section.

The locking features provided in channels 116 and 121 are also selected based on the configuration of the sheath of the cable to be terminated by apparatus 100. For example, where the sheath has annular corrugations, the locking features may comprise locking ridges 118 and 128 as described above. As shown in FIG. 6A, locking ridge 128 extends laterally across channel 116. Locking ridge 118 may be correspondingly positioned. Where the sheath has helical corrugations, an angled locking ridge 128B may be provided in channel 121 of cap 120, as shown in FIG. 6B, and a correspondingly positioned locking ridge (not shown) may be provided in channel 116 of extension 115.

Other types of locking features may also be provided. For example, FIG. 6C shows an embodiment wherein a plurality of protrusions 128C extend into channel 121 of cap 120 to act as the locking features. Similar protrusions 118C may also extend into channel 116 of extension 115, as shown in FIG. 6D, which is an end view.

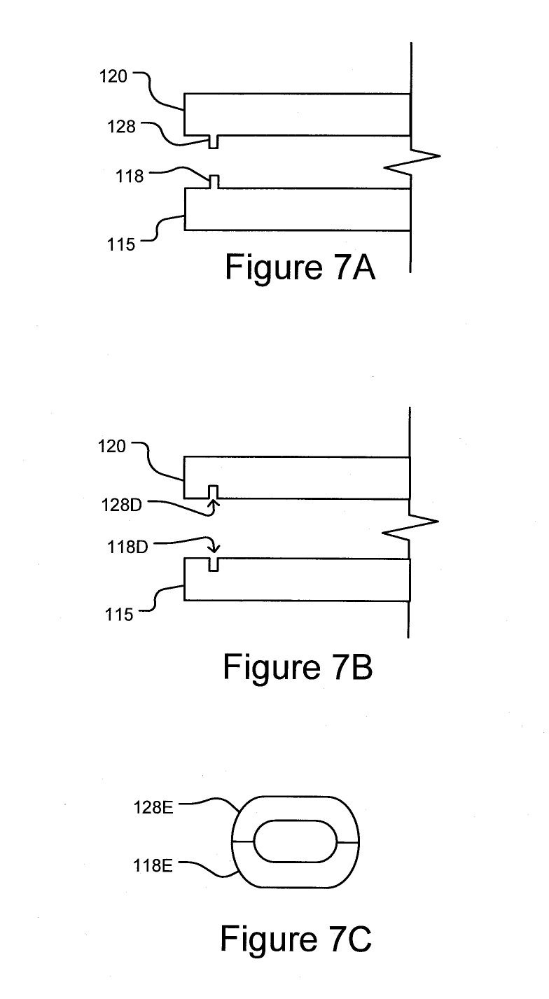

As noted above, locking ridges 118 and 128 may be integrally formed with extension 115 and cap 120, respectively, as shown in FIG. 7A. FIGS. 7B and 7C show another embodiment wherein the locking features comprise grooves 118D and 128D defined in extension 115 and cap 120, respectively, and a split washer comprising washer portions 118E and 128E configured to be received in grooves 118D and 128D, respectively. Other variations of the locking features are also possible. For example, an O-ring could be provided instead of a split washer in some embodiments having grooves 118D and 128D, wherein the O-ring is positioned over the sheath of the cable before installation.

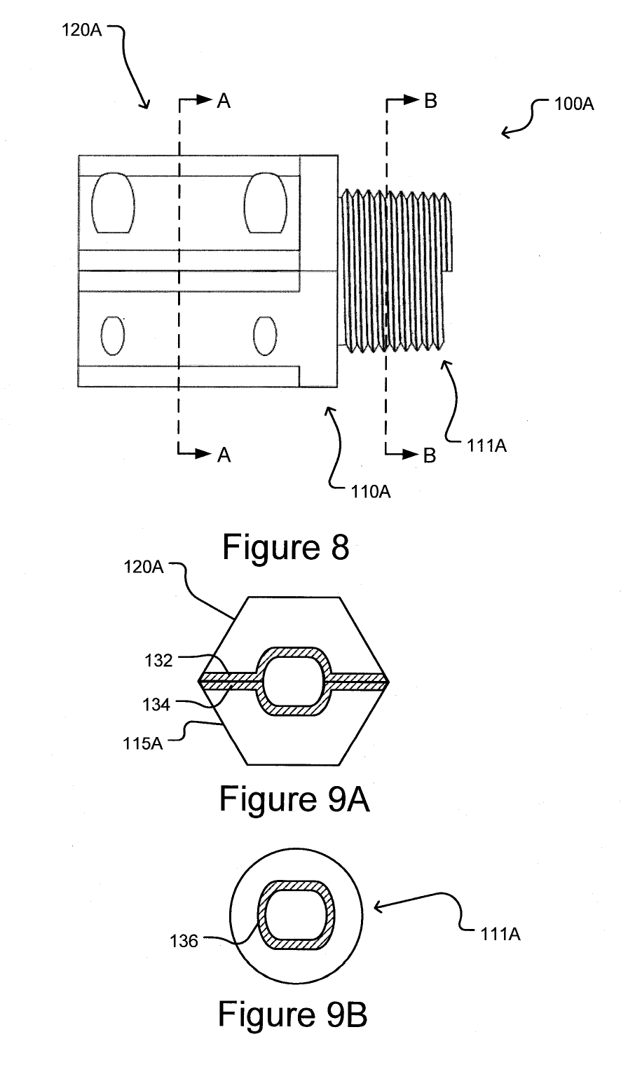

FIGS. 8 and 9A-B show a termination apparatus 100A according to another embodiment. Termination apparatus 100A has a similar construction to that of termination apparatus 100 of FIGS. 1 to 3, and as such only differences between apparatus 100A and apparatus 100 are described herein to avoid repetition. Apparatus 100A differs from apparatus 100 in that cap 120A and extension 115A have compressible portions 132 and 134 along their respective channels and opposed flat surfaces (see FIG. 9A), and terminating portion 111A has a compressible portion 136 lining the inside of the aperture (see FIG. 9B). Compressible portions 132, 134 and 136 provide an environmental seal against the sheath of a cable without requiring a separate boot. In the embodiment of FIGS. 8 and 9A-B, body 110A and cap 120A may be made, for example from a hard plastic material, and compressible portions 132, 134 and 136 may be made from a lower durometer plastic, or from rubber.

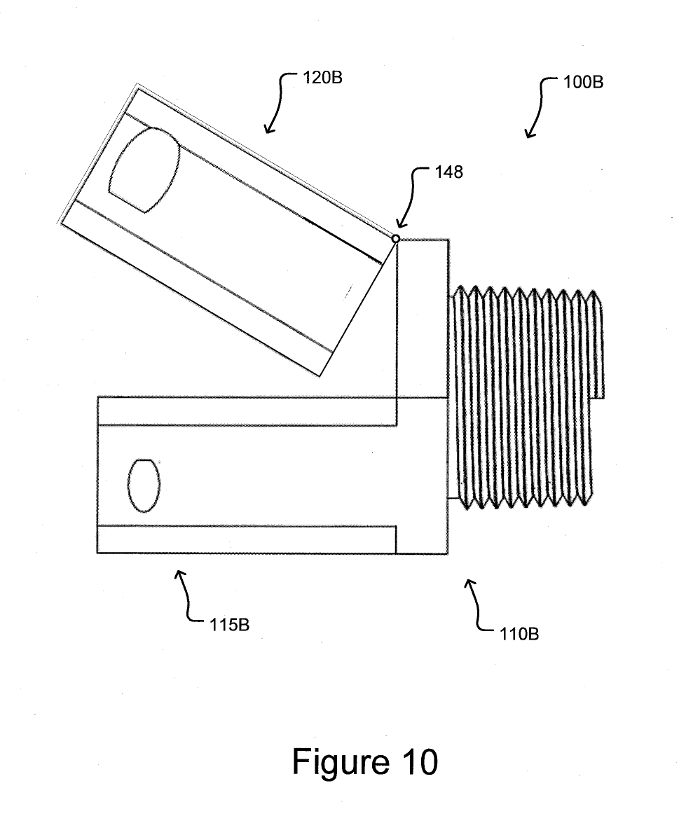

FIG. 10 shows a termination apparatus 100B according to another embodiment. Termination apparatus 100B has a similar construction to that of termination apparatus 100 of FIGS. 1 to 3, and as such only differences between apparatus 100B and apparatus 100 are described herein to avoid repetition. Apparatus 100B differs from apparatus 100 in that cap 120B is pivotally coupled to body 110B by a hinge 148. Hinge 148 may be formed, for example, by providing interleaved protrusions extending from both cap 120B and body 110B with lateral holes therein, through which a hinge pin may be inserted to couple cap 120B to body 110B. One or more fasteners (not shown in FIG. 10) may be provided at or near the cable-receiving end of apparatus 100B for securing cap 120B against extension 115B. Suitable fasteners include threaded fasteners, a steel strap, a pipe strap, a nylon tie, or other types of fasteners.

Although the description has been described with respect to particular embodiments thereof, these particular embodiments are merely illustrative, and not restrictive.

It will also be appreciated that one or more of the elements depicted in the drawings/figures can also be implemented in a more separated or integrated manner, or even removed or rendered as inoperable in certain cases, as is useful in accordance with a particular application.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. An apparatus for terminating a cable having a corrugated sheath, the apparatus comprising:
a body having a terminating portion and a cable receiving portion, the terminating portion having an aperture defined therethrough, the cable receiving portion comprising an extension projecting outwardly in a direction away from the terminating portion, the extension having an extension channel defined in a central portion thereof and one or more locking features protruding into the extension channel near an outward end thereof;
a cap configured to be secured to the extension of the body, the cap having a cap channel defined in a central portion thereof and one or more locking features protruding into the cap channel near an outward end thereof; and
one or more fasteners for securing the cap to the extension of the body,
wherein when the cap is secured to the extension the extension channel and the cap channel cooperate to define a compression chamber therebetween, the compression chamber being generally aligned with the aperture through the terminating portion, and
wherein the locking features protruding into the extension channel and the cap channel are configured to engage the corrugated sheath of the cable.

2. An apparatus according to claim 1 comprising a boot made from a compressible material, the boot configured to be positioned over the end of the cable such that the boot is compressed against the corrugated sheath between the cap channel and the extension channel when the cap is secured to the extension to form a seal.

3. An apparatus according to claim 1 wherein the cap comprises a compressible cap portion formed along the cap channel and surfaces adjacent thereto which abut the extension, and the extension comprises a compressible extension portion formed along the extension channel and surfaces adjacent thereto which abut the cap, such that the compressible cap portion and the compressible extension portion are compressed against the corrugated sheath when the cap is secured to the extension to form a seal.

4. An apparatus according to claim 3 wherein the terminating portion comprises a compressible portion formed along the aperture.

5. An apparatus according to claim 1 wherein the cap is pivotally coupled to the body by a hinge.

6. An apparatus according to claim 1 wherein the aperture and the compression chamber have generally oval-shaped cross-sections.

7. An apparatus according to claim 1 wherein the aperture and the compression chamber have generally circular cross-sections.

8. An apparatus according to claim 1 wherein the body and the cap are formed from electrically conductive materials to provide electrical grounding for the corrugated sheath.

9. An apparatus according to claim 1 wherein the one or more locking features of the extension comprises an extension locking ridge, and the one or more locking features of the cap comprises a cap locking ridge.

10. An apparatus according to claim 9 wherein the extension and cap locking ridges are oriented laterally across the extension and cap channels to engage annular corrugations of the corrugated sheath.

11. An apparatus according to claim 9 wherein the extension and cap locking ridges are oriented at angles across the extension and cap channels to engage helical corrugations of the corrugated sheath.

12. An apparatus according to claim 1 wherein the one or more locking features of the extension comprises a plurality of extension protrusions, and the one or more locking features of the cap comprises a plurality of cap protrusions.

13. An apparatus according to claim 9 wherein the one or more locking features of the extension are integrally formed with the extension, and the one or more locking features of the cap are integrally formed with the cap.

14. An apparatus according to claim 1 wherein the one or more locking features of the extension comprises an extension groove and an extension washer portion configured to be received in the extension groove, and the one or more locking features of the cap comprises a cap groove and a cap washer portion configured to be received in the cap groove.

15. A method of terminating a cable having a corrugated sheath, the method comprising:
providing a body having a terminating portion and a cable receiving portion, the terminating portion having an aperture defined therethrough, the cable receiving portion comprising an extension projecting outwardly in a direction away from the terminating portion, the extension having an extension channel defined in a central portion thereof and one or more locking features protruding into the extension channel near an outward end thereof, and a cap configured to be secured to the extension of the body, the cap having a cap channel defined in a central portion thereof and one or more locking features protruding into the cap channel near an outward end thereof;
coupling the terminating portion to an electrical enclosure;
inserting an end of the corrugated sheath through the aperture in the terminating portion and positioning the corrugated sheath in the extension channel such that the one or more locking features of the extension engage a corrugation of the corrugated sheath; and,
securing the cap to the extension using one or more fasteners, such that the extension channel and the cap channel cooperate to define a compression chamber around the corrugated sheath, the compression chamber being generally aligned with the aperture through the terminating portion, and such that the one or more locking features of the cap engage a corrugation of the corrugated sheath.

16. A method according to claim 15 comprising, before inserting the end of the corrugated sheath through the aperture:
positioning a boot made from a compressible material over the end of the corrugated sheath,
such that the boot is compressed against the corrugated sheath between the cap channel and the extension channel when the cap is secured to the extension to form a seal.

17. A method according to claim 15 comprising, before inserting the end of the corrugated sheath through the aperture:
wrapping the end of the corrugated sheath with tape, such that the tape is compressed against the corrugated sheath between the cap channel and the extension channel when the cap is secured to the extension to form a seal.
